(19) United States
(12) Patent Application Publication
(10) Pub. No.: US 2001/0052592 A1
(43) Pub. Date: Dec. 20, 2001

(54) Low cost vehicle safety jack

(76) Inventor: Daniel V. Alvarado, San Antonio, TX (US)

Correspondence Address: TRACY W. DRUCE, KILPATRICK STOCKTON LLP, 11130 SUNRISE VALLEY DRIVE, SUITE 300, RESTON, VA, 20191-4329, US

(21) Appl. No.: 09/726,209

(22) Filed: Nov. 29, 2000

Related U.S. Application Data
(60) Provisional application No. 60/167,752, filed on Nov. 29, 1999.

(51) Int. Cl. B66F 3/08

(52) U.S. Cl. 254/13

(57) ABSTRACT

A safety jack, comprising a gear housing having a base wall connected to a rear wall, the base wall having a hole formed therein and the rear wall including an opening. A leg housing, formed from a hollow tube of rectangular cross section, has a connecting end and an open end, the connecting end being bonded to the base wall of the gear housing in co-axial alignment with the hole formed in the base wall of the gear housing. The leg housing accommodates a support leg that is free to slide in and out of the leg housing. The support leg is a hollow tube of rectangular cross section having an upper end and a lower end with a ball nut bonded inside the upper end of the support leg. There is a stabilizing foot attached to the lower end of the support leg and the ball nut has internal threads. A threaded portion of a ball screw passes through the ball nut to engage the internal threads, there being axial alignment of the ball screw with the ball nut, the support leg and the at least one hole of the base wall of the gear housing. An end of the ball screw passes through the hole of the base wall for engagement inside the gear housing with a drive mechanism that imparts reversible rotation to the ball screw, to move the support leg towards and away from the gear housing. Each of the gear housing, the leg housing and the support leg are formed from sized sections of box beam.

### RELATED PATENT APPLICATIONS

This patent application claims priority to U.S. Provisional Application No. 60/167,752 filed Nov. 29, 1999 and also entitled LOW COST VEHICLE SAFETY JACK, the disclosure of which is expressly incorporated by reference in its entirety.

### DESCRIPTION

1. Technical Field

The present invention relates generally to vehicle jacks, and more specifically to a low cost, electrically driven apparatus for raising at least a portion of a vehicle to provide clearance between the portion of the vehicle and the ground.

2. Background Art

The potential for vehicle breakdown requires the carrying of auxiliary equipment for use during an emergency. One item of equipment, carried in various forms since the earliest days of motoring, is a jack or system of jacks for raising the vehicle above the ground. The need to elevate the vehicle may occur to replace a wheel, after puncture of a tire, or for access to the underside of the vehicle. Vehicle jacks may be manually operated, most frequently by attaching the jack to a designated location of the vehicle frame, or remotely operated when one or more jacks have been permanently attached to the frame of the vehicle. Such installed jacks are known and tend to include jacks positioned close to the wheels of the vehicle. For example United States patents U.S. Pat. No. 2,131,296 and U.S. Pat. No. 2,241,877 describe jacks powered by electricity from the vehicle battery. In both cases an electrical motor transmits rotational motion through a series of gears and threaded rods to convert the rotation to the linear motion for raising or lowering the vehicle. Similarly United States patent U.S. Pat. No. 4,635,904 describes a jack that may be used for elevating or leveling vehicles, such as recreational vehicles, that require height adjustment to compensate for uneven terrain.

The references of the prior art use precision machined or cast housings for containment of the moving parts, especially the gear mechanism, of the vehicle jack structures. It is noticeable that these housings represent several pieces that need to be screwed, bolted or pinned together. Such connecting elements may loosen and fall out of the housings with the possible result that the jack will be rendered inoperative. In some cases, support elements, such as a support post with an attached stabilizing foot, also appear subject to design considerations requiring manufacture of specific parts. Detailed design and production of parts, to meet requirements of a particular vehicle jack, undoubtedly adds cost to the product when compared to an alternative that uses readily available, mass produced components connected without the use of fugitive connecting elements.

In view of the above described deficiencies associated with the use of known designs for vehicle jacks, the present invention has been developed to alleviate these drawbacks and provide further benefits to the user. These enhancements and benefits are described in greater detail hereinbelow with respect to several alternative embodiments of the present invention.

### DISCLOSURE OF THE INVENTION

The present invention in its several disclosed embodiments alleviates the drawbacks described above with respect to the cost of conventionally designed vehicle jacks and incorporates several additionally beneficial features based upon readily available structural materials.

The present invention comprises a remote controller electrically connected to a direct current motor that is attached to a gear housing. The gear housing attaches to the top of a vertical leg housing that attaches to a vehicle frame. The leg housing contains a hollow support leg with an stabilizing foot. A ball nut, attached to the support leg and stabilizing foot structure, engages the threads of a threaded rod or ball screw that extends down the center of the hollow support leg. The ball screw rotates relative to a thrust bearing that provides an opening in the top of the leg housing, through which the ball screw extends for connection to a drive mechanism. A worm drive and wheel gear, connected to the end of the ball screw extending through the leg housing, may be used, as a drive unit, for rotation of the ball screw. The worm and gear drive unit reside inside a gear housing. A direct current electric motor, attached to the gear housing, provides power to a drive shaft coupling the worm gear to the electric motor. When the direct current motor is energized, the ball screw is rotated by the worm drive and wheel gear arrangement. This causes the support leg and stabilizing foot to project further from the base of the leg housing, in response to travel of the ball nut down the rotating ball screw.

The low cost jack, according to the present invention, includes a mounting plate or bracket to rigidly attach the jack to a structure, such as a vehicle, to allow the structure to be raised in an emergency or for access beneath the structure, to e.g. maintain the structure. During operation of the jack, when the articulated foot meets resistance to its movement, as when making contact with the ground, the foot, support leg and ball nut become stationary and continuing rotation of the ball screw operates against the ball nut causing the leg housing to move away from the foot of the vehicle jack. This motion causes elevation of any structure, such as a vehicle frame, that may be coupled to the leg housing, by the mounting bracket. Once a structure or vehicle has reached a desired elevation, the vehicle jack, according to the present invention, safely supports the structure or vehicle during completion of a repair or maintenance task, such as replacing a wheel of a vehicle with a punctured tire. After repair or maintenance, the structure or vehicle may be returned to its original, stable condition by reversing the direction of rotation of the ball screw.

During raising and lowering of the structure or vehicle, the operator may safely stand a distance away from the operating jack since the controls, used to drive the electric motor, may be located in a suitably remote location either inside or outside of the structure or vehicle.

A distinguishing feature of the present invention is the use of readily available components suitable for fabricating the gear housing, the leg housing, the support leg and the stabilizing foot attached thereto. Whereas remotely operated jacks previously required the machining or casting of complex structures for these parts, the present invention uses sections of hollow metal box beam substituting welded connections to replace the bolted connections of previous equipment. The use of welded parts avoids the problem that connecting elements, such as bolts, screws and machine pins may fail and place previously disclosed vehicle jacks in an inoperative condition.

More particularly the invention provides a low cost safety jack, comprising a gear housing having a base wall connected to a rear wall, the base wall having at least one hole formed therein and the rear wall including at least one opening. A leg housing, formed from a hollow tube of rectangular cross section, has a connecting end and an open end, the connecting end being bonded to the base wall of the gear housing with the longitudinal axis of the leg housing co-axially aligned with the hole formed in the base wall of the gear housing. The leg housing accommodates a support leg that is free to slide in and out of the leg housing. The support leg is a hollow tube of rectangular cross section having an upper end and a lower end with a ball nut bonded inside the upper end of the support leg. There is a stabilizing foot attached to the lower end of the support leg and the ball nut has internal threads. A threaded portion of a ball screw passes through the ball nut to engage the internal threads, there being axial alignment of the ball screw with the ball nut, the support leg and the at least one hole of the base wall of the gear housing. The ball screw has a first end and a second end with the first end of the ball screw passing through the hole of the base wall for engagement inside the gear housing with a drive mechanism to impart reversible rotation to the ball screw, to move the support leg towards and away from the gear housing. Each of the gear housing, the leg housing and the support leg are formed from sized sections of box beam.

### DEFINITIONS OF TERMS

Some terms used herein are defined as follows:

Box Beam means a sturdy, rigid, elongate hollow tube having rectangular cross section. The box beam provides material a the gear housing, leg housing, support leg and stabilizing foot according to the current invention. Box beams are generally produced in lengths suitable for support structures such as scaffolding.

Ball screw means a cylindrical rod having a threaded portion and an end for attachment to a drive mechanism that provides reversible rotation to the ball screw.

Drive mechanism means an arrangement of a motor and gear elements which, when energized transmit rotational movement to a ball screw.

The beneficial effects described above apply generally to the exemplary devices and mechanisms disclosed herein of the motor vehicle safety jack. The specific structures through which these benefits are delivered will be described in detail hereinbelow.

### BRIEF DESCRIPTION OF THE DRAWINGS

The invention will now be described in greater detail in the following way of example only and with reference to the attached drawings, in which:

FIG. 1 is a perspective view of a vehicle jack according to the present invention, showing the commonly available structures that may be used for its construction.

FIG. 2 is a perspective view of a vehicle jack showing the leg housing further from the stabilizing foot.

FIG. 3 is a front view of the vehicle jack of the present invention including a cutaway section to show the moving parts for raising and lowering the jack.

### MODE(S) FOR CARRYING OUT THE INVENTION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

Furthermore, elements may be recited as being “coupled”; this terminology's use contemplates elements being connected together in such a way that there may be other components interstitially located between the specified elements, and that the elements so specified may be connected in fixed or movable relation one to the other.

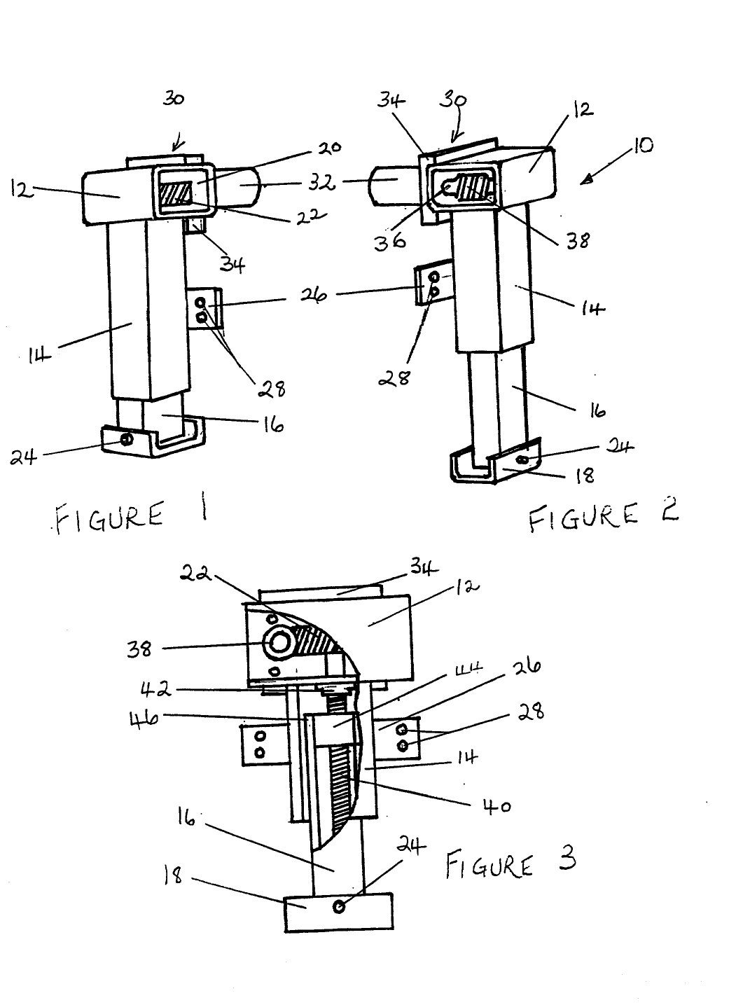

Referring to the figures, wherein like numbers signify like part throughout the several views, FIG. 1 and FIG. 2 provide perspective views of the external features a jack 10, according to the present invention. Several parts, including the gear housing 12, leg housing 14, support leg 16 and stabilizing foot 18 may be fabricated from readily available sections of hollow tubing having a rectangular cross section. This type of tubing is more commonly referred to as box beam, available in a variety of lengths and rectangular cross sectional dimensions. The openness of gear housing 12 may be appreciated by observation of its open end 20 which exposes the wheel gear 22 used to transmit rotational force to deploy the support leg 16. It is clear from the open end 20 profile, that the gear housing 12 may be constructed from a section of box beam. The gear housing 12 may be attached to the leg housing 14 using suitable welding techniques to make a permanent connection between the two. A section of box beam may be used for the leg housing. Similarly, the support leg 16 and the stabilizing foot 18 may be cut from sections of box beam of suitable dimensions for sliding alignment of the support leg 16 inside the leg housing 14 and pivotal adjustment of the stabilizing foot 18 relative to the end of the support leg 16 that protrudes from the leg housing 14. A pivot pin 24 passing through the support leg 16 and the stabilizing foot 18 provides a suitable axis for limited rotation, i.e. pivoting of the foot 18 relative to the support leg 16.

The vehicle jack 10, shown in FIG. 1, includes a mounting bracket 26 to allow direct mounting of the jack 10 to the frame or other support element of the vehicle. Holes 28 in the mounting bracket 26 may be used for releasable attachment of the jack 10 to the vehicle. Alternatively, the mounting bracket 26 may be welded directly to the vehicle frame. Whatever form of attachment may be used, the vehicle jack 10 may be strategically placed on the vehicle, such as near a wheel well, so that it is readily available for operation during maintenance or emergency breakdown necessitating a tire change. Another use for the jack is in leveling structures including sheds, campers, trailers, recreational vehicles and the like while parked or installed over uneven terrain. Operation of the captive jack 10 requires a drive mechanism 30 (see FIG. 3). Power for the drive mechanism 30 may be supplied by an electric motor 32 using a mounting plate 34 for attachment to the side of the gear housing 12. The electric motor 32 may be attached using a bolted or welded connection. A drive shaft 36 from the electric motor 32 passes through a hole in the side-wall of the gear housing 12 to couple with a worm gear 38 that transmits rotational force from the electric motor 32 to the wheel gear 22. The drive shaft 36 and worm gear 38 combination rotate in a bushing (not shown) fixedly positioned on the inside wall of the gear housing. The wheel gear 22 connects to the upper end of a cylindrical rod, referred to herein as a ball screw 40 shown more clearly, with other moving parts of the vehicle jack 10, by reference to FIG. 3. The ball screw 40 passes through a hole in the base of the gear housing 12. A thrust bearing 42 aligns axially with the hole in the base of the gear housing 12 to provide support and facilitate rotation of the ball screw 40. A threaded section of the ball screw 40 passes through and engages a ball nut 44 that is fixed to the upper end 46 of the support leg 16. When energized, the electric motor 32 provides power to the drive shaft 36 which rotates the worm gear 38, causing the wheel gear 22 to follow this motion to transmit rotational force to the ball screw 40. As the ball screw 40 rotates, its engagement with the ball nut 44 causes linear motion of the ball nut 44 either towards the gear housing 12 or away from it, depending on the direction of rotation of the ball screw 40. The fixed relationship between the ball nut 44 and the support leg 16 causes the support leg 16 to execute motion corresponding to the motion of the ball nut 44. Movement of the ball nut 44 towards the gear housing 12 pulls the support leg 16 further into the leg housing 14. The support leg 16 extends further from the leg housing 14 as the ball nut 44 is driven away from the gear housing 12 by rotation of the ball screw 44. With the jack 10 mounted on the frame of a vehicle the movement of the support leg 16, into and out of the leg housing 14, translates into raising and lowering of the vehicle as long as the stabilizing foot 18 stays in contact with the ground. Forward and reverse thrust of the electric motor 32, therefore, allows height adjustment of a vehicle or other suitable structure for leveling, repair or maintenance depending on the need.

The distinguishing feature of the present invention is the discovery by the inventor of housings 12, 14 and parts assembly including readily available box beam sections, using welding techniques. For example the gear housing 12, made from a section of box beam may be suitably drilled to accommodate the electric motor 32 and the ball screw 40 and a thrust bearing 42 may be attached, around the ball screw hole, at the outer surface of the base of the gear housing 12. A second section of suitable sized box beam forms the leg housing 14 for attachment, preferably by welding, to the base of the gear housing 12 such that the longitudinal axis of the leg housing 14 is coaxial with the thrust bearing 42 for the ball screw 40. A ball nut, having essentially square cross section, may be welded or otherwise secured inside the upper end of a third, suitably sized, section of box beam which forms the support leg 16. A stabilizing foot 18 attached to the other end of the support leg 16, using a pivot pin 24, may also be fabricated from a section of box beam. The support leg 16 may be threaded onto the ball screw 40 by engaging the ball nut 44 internal threads with the threads on the ball screw 40. Once inserted in the ball nut 44, withdrawal of the ball screw 40 may be prevented by placement of a machine pin or a cotter pin (not shown) to extend beyond the width of the ball screw 40, at the end of the ball screw 40 closest to the stabilizing foot 18. Following this preparation, the ball screw 40 may be inserted through the thrust bearing 42 to connect to the wheel gear 22 inside the gear housing 12. Next, the worm gear 38 may be placed in engagement with the wheel gear 22 before attaching it to the drive shaft 36 of the electric motor 32 that is connected to the rear surface of the gear housing 12. Before assembling the vehicle jack 10, as previously described, a mounting bracket 26 may be attached to the leg housing 14, preferably by welding, to facilitate attachment of the jack 10 to the vehicle or other structure that may need height adjustment.

After assembling the jack 10 and mounting it to the vehicle, electrical connection may be made from the electric motor 32 to a suitable remote control switch and thence to a connection to the vehicle battery circuit. Preferably the control switch will be located to allow the operator to observe the operation of the jack 10 during the elevating or leveling of the vehicle. Remote positioning of the control switch adds safety to the use of the jack 10. The control circuit should include provision for forward and reverse operation of ball screw 40 so that, once extended, the support leg 16 may also be retracted.

The preferably welded elevating jack structure 10, according to the present invention, provides a rugged, vehicle jack for mounting to a vehicle frame. Welding allows removal of the multiple connecting elements such as screws, nuts, bolts and machine pins, common in the prior art, and produces a unit of comparatively simple manufacture, while maintaining secure interconnection of parts. It is surprising that the relatively precise engineering associated with the interactions of moving parts, to extend and retract the support leg 16, may be transferred to a containment structure, comprising the gear housing 12 and the leg housing 14, not specifically designed, machined or cast to complement the drive mechanism 20. Positioning and alignment of parts, according to the present invention, for successful vehicle jack operation may be attributed to the skill of the welder, using readily available, mass produced materials to provide cost advantages without compromising performance.

A low cost vehicle safety jack, its components and alternative uses have been described herein. These and other variations, which will be appreciated by those skilled in the art, are within the intended scope of this invention as claimed below. As previously stated, detailed embodiments of the present invention are disclosed herein; however, it is to be understood that the disclosed embodiments are merely exemplary of the invention that may be embodied in various forms.

What is claimed and desired to be secured by Letters Patent is as follows:

1. A low cost safety jack, comprising:
a gear housing having a base wall connected to a rear wall, said base wall having at least one hole formed therein, said rear wall including at least one opening;
a leg housing, formed from a hollow tube of rectangular cross section, said leg housing having a connecting end and an open end, said connecting end bonded to said base wall of said gear housing with the longitudinal axis of said leg housing co-axially aligned with said hole formed in said base wall of said gear housing;
a support leg slidingly received inside said leg housing, said support leg being a hollow tube of rectangular cross section, said support leg having an upper end and a lower end, a ball nut being bonded inside said upper end of said support leg, there being a stabilizing foot attached to the lower end thereof, said ball nut having internal threads;
a ball screw having a threaded portion, a first end and a second end, said threaded portion passing through said ball nut to engage said internal threads, there being axial alignment of said ball screw with said ball nut, said support leg and said at least one hole of said base wall of said gear housing, said first end of said ball screw passing through said at least one hole of said base wall for engagement inside said gear housing with a drive mechanism to impart reversible rotation to said ball screw, to move said support leg towards and away from said gear housing, said gear housing, said leg housing and said support leg being formed from sized sections of box beam.
